(19) United States
(12) Patent Application Publication
(10) Pub. No.: US 2025/0283204 A1
(43) Pub. Date: Sep. 11, 2025

(54) FLEXIBLE CORD FOR SUPPLYING A THERMAL SPRAY TORCH AND THERMAL SPRAY DEVICE

(71) Applicant: SAINT-GOBAIN CENTRE DE RECHERCHES ET D'ETUDES EUROPEEN, COURBEVOIE (FR)

(72) Inventors: Dominique BILLIERES, CAVAILLON (FR); Bernard BOUTEILLER, CAVAILLON (FR); Cédric BRICQUET, CAVAILLON (FR); Jarkko KIILAKOSKI, CAVAILLON (FR)

(21) Appl. No.: 18/862,524

(22) PCT Filed: May 4, 2023
(86) PCT No.: PCT/EP2023/061765

§ 371 Date: Nov. 1, 2024

(30) Foreign Application Priority Data
May 4, 2022 (FR) FR2204223

(51) Int. Cl. C23C 4/123; B05B 7/20; C23C 4/04

(52) U.S. Cl. CPC C23C 4/123; B05B 7/201; C23C 4/04

(57) ABSTRACT

Cord having an equivalent outside diameter (d) of between 1 mm and 3.5 mm and consisting of a core (18) in the form of a wire, and a sheath (20) covering the core along its entire length, the core consisting
of a collection of inorganic particles (22) of which the median size (D₅₀) is less than 10 micrometers, the inorganic particles representing more than 40% and less than 80% of the volume of the core; and
of a matrix (24) binding said inorganic particles, the matrix comprising a polymer binder and optionally a matrix lubricant, these together representing more than 90% of the volume of the matrix;
the sheath having a thickness of between 50 micrometers and 500 micrometers and comprising a sheath polymer and preferably a sheath lubricant, these together representing more than 90% of the volume of the sheath,
the volume percentages being determined without accounting for the possible presence of a solvent.

### TECHNICAL FIELD

The invention relates to a flexible cord intended to serve as feedstock for a thermal spray torch, in order to create a coating. It also relates to a method for manufacturing said cord and to a thermal spray device using said cord.

### PRIOR ART

The technique of thermal spraying consists in using a source of thermal and kinetic energy to melt a collection of inorganic particles, initially in the form of a wire or of a powder, and spray the at least partially molten particles onto a substrate. Upon impact, the at least partially molten particles spread out and cool on the substrate. They can thus adhere effectively to one another and to the substrate as they cool, and form a coating.

There are various technologies which can be classified into the classes “combustion enthalpy”, “electric discharge” and “momentum density”.

The “combustion enthalpy” class comprises the “detonation gun” and “powder flame” technologies (generating particle velocities <80 m/s and able to use only powders as feedstock), the “wire flame” technology (generating particle velocities >150 m/s and able to use as feedstock a medium selected from a wire, a cord or a rod), and finally “high-velocity flame” technology (generating particle velocities >500 m/s). Among the “high-velocity flame” technologies, a distinction can be made between the “D-gun detonation”, “HVOF” (High Velocity Oxy-Fuel), “HVSFS” (High Velocity Suspension Flame Spray) and “HVAF” (High Velocity Air Fuel) technologies which are able, as feedstock, to use powders, suspensions (in the case of HVSFS) or even wires.

The “electric discharge” class comprises the “electric arc” and “plasma” technologies, the latter category including the methods referred to as “atmospheric”, or APS (Atmospheric Plasma Spray), methods performed in controlled atmospheres and temperatures, for example “VPS/LPPS” (Vacuum or Low Pressure Plasma Spray), “VLPPS/PS-PVD” (Very low pressure plasma spray and Plasma Spray enhanced Physical Vapor Deposition), “SPS” (Suspension Plasma Spray), “SPPS” (Solution Precursor Plasma Spray), “Induction Plasma”, and “WSP” (Water Stabilized Plasma) technologies. These systems enable the particles to be propelled at velocities that may range from 150 m/s to 500 m/s depending on the method variant and parameters employed. These “plasma” systems can be used with dry powders of which the particle size distribution is such that the median size D₅₀ is typically greater than 10 micrometers, or liquids (chemical precursors such as salts, or suspensions containing inorganic particles of which the median size D₅₀ is less than micrometers).

The “momentum density” class comprises the “Cold Spray” technologies which includes the “low-pressure”, “high-pressure” and “recirculated helium” technologies.

All of these technologies are well-known and notably described in the work “ASM Handbook vol 5a—Thermal Spray Technology”.

Each technology is associated with its own specific constraints, so that the problems encountered, and the solutions employed for overcoming them generally differ according to the technology considered.

The invention is particularly concerned with the subset grouping:
in the “combustion enthalpy” class, the “flame-wire” and “high-velocity flame” technologies; and
the technologies from the “electric discharge” class, particularly the “plasma” technologies.

For the sake of clarity, in the present description and generically, a torch or a gun used in these technologies will be referred to as a “torch”. The term “torch” in particular includes a flame gun of the flame-wire (WFS or Wire Flame Spray) type, or else a plasma torch system, or finally, a “High-Velocity Flame Spray” device as defined above. A recent evolution in these technologies consists in using, as feedstock, in these devices, suspensions or solutions of liquid precursors (the suspensions consisting of a solvent and of fine inorganic particles having a median size D₅₀ typically less than 5 micrometers). This evolution toward very fine particles, (or even the in situ formation of the material in the case of liquid precursor) has made it possible to generate new types of microstructures, for example very finely structured, very dense, or else columnar or “feathery” microstructures (which have the appearance of a juxtaposition of feathers when observed in micro-graphic cross section). These evolutions open the way to new prospects, but run up against constraints and limitations of method robustness, stability, and repeatability which are associated with the fact that the particle suspensions are not always perfectly stable. The vaporization of the solvent is, however, detrimental to the energy efficiency during the spray phase. Moreover, when the suspensions contain particles of different compositions notably having different densities. The formulation of such stable suspensions, without any sedimentation or clumping of the particles, is difficult if not to say impossible to master on an industrial scale.

JP2016156058A describes a feedstock medium consisting of a composite wire. The coating is a dense electrolytic film for the creation of fuel cells. Such a wire may be difficult to manufacture and does not allow the creation of ceramic (for example oxide) coatings with good control over the size of the sprayed particles. In particular, this medium comprises fine particles embedded in a matrix. Tests have demonstrated that the large quantity of matrix leads, during spraying, to detrimental variations in enthalpy.

U.S. Pat. No. 4,593,856 also describes a feedstock medium in the form of a wire. The melting of the wire may, however, be incomplete, and this is detrimental to the quality of the coating.

Cords comprising a core coated with a sheath as a feedstock for welding torches for applying thick layers (overlays or hardfacing) metallurgically bonded to a metal support are known. They are not suitable for producing coatings by thermal spraying, which coatings may be applied without resorting to a welding step, and may consist of ceramics and be applied to any type of support. These cords intended for welding consist of inorganic particles of a size greater than 10 micrometers.

An arc-welding cord is also known, from U.S. Pat. No. 3,701,444. Such a cord is not conventionally used as feedstock for a thermal spraying torch to create a coating as these two applications (welding/spraying) are very different than one another. In particular, the collection of inorganic particles generally has a median diameter greater than or equal to 100 micrometers.

FR 1 443 142 finally describes a cord which comprises a core coated with a sheath. The collection of inorganic particles has a median size D₅₀ that is incompatible with the obtaining of a coating that is highly uniform or finely structured.

There is therefore an on-going need for a feedstock medium suitable for spraying using a plasma torch or flame torch:
allowing the torch to be fed substantially continuously, and reliably,
making it possible to overcome the constraints and limitations of the media of the liquid suspension or liquid solution type, particularly by being in a form that is solid and stable, easy to handle, and preferably that can be wound onto a reel;
leading to a coating that is highly uniform or finely structured;
without excessive abrasion of the torch; and
at the expense of limited energy consumption.

The present invention seeks to at least partially meet this need.

### BRIEF DESCRIPTION OF THE INVENTION

According to the invention, this objective is achieved by means of a cord having an equivalent outside diameter of between 1 mm and 3.5 mm and consisting of a core, or “center” in the form of a wire, and a sheath covering the core along its entire length, the core consisting
of a collection of inorganic particles of which the median size D₅₀ is less than 10 micrometers, the inorganic particles representing more than 40% and less than 80% of the volume of the core; and
of a matrix binding said inorganic particles, the matrix comprising a polymer binder and optionally a matrix lubricant, for example glycerin, these together representing more than 90% of the volume of the matrix, the complement to 100% being able to consist of impurities;
the sheath having a thickness of between 50 micrometers and 500 micrometers and comprising a sheath polymer and preferably a sheath lubricant, identical to or different than the optional matrix lubricant, these together representing more than 90% of the volume of the sheath, the complement to 100% preferably consisting of impurities and possibly of a colorant pigment,
the volume percentages being determined without accounting for the possible presence of solvent residue.

Surprisingly, the inventors have discovered that a cord according to the invention allows the torch to be fed continuously and reliably while at the same time leading to a high-quality coating offering a number of advantages over the use of suspensions of fine particles:
better stability of the method and elimination of the problems associated with the stability of the particle suspensions (risks of sedimentation, clumping);
lower energy consumption because of the absence of evaporation of the aqueous solvents used in the suspensions;
absence of clumping of particles at the point of injection or in flight, unlike that which is observed during thermal spraying of a suspension;
better control of the flowrate of inorganic material, advantageously proportional to the speed at which the cord is fed into the spray device, whereas the injection of suspension leads to significant variations in this flowrate.

Moreover, a feedstock medium in the form of a cord advantageously contains far less solvent than a suspension. The low solvent, particularly water, content of a cord, which is typically less than 5% by mass, considerably limits the energy losses in the thermal spraying of the medium aimed at completely or partially melting the inorganic particles.

Without being bound by this theory, the inventors have finally found that the characteristics of the cord lead, at the time of spraying, to only a small variation in enthalpy. The variation in enthalpy therefore has a far less disruptive influence on the thermal spraying process than in the spraying of dry powders and the use of cords of the prior art. In particular, the inventors have found that the combination of a core containing a fairly low matrix content and of a sheath allows a more reliable variation in enthalpy than a composite cord without a sheath and having a higher matrix content as in JP2016156058A. In general, the presence of a minimal quantity of polymer is necessary, particularly in order to confer the required flexibility, and the inventors have discovered that increasing the concentration of inorganic particles in the core of the cord and the addition of a sheath in order to maintain this flexibility were preferable to a lower concentration of inorganic particles in a composite cord.

In one particularly advantageous embodiment, the ratio R of the equivalent outside diameter of the cord, in micrometers, to the median size of the collection of inorganic particles, in micrometers, is comprised between 200 and 20 000, and preferably between 200 and 1600. Remarkably, this configuration, associated with a volume content of inorganic particles, with respect to the volume of the core of said cord, comprised between more than 40%, preferably more than 50%, or even more than 60%, and less than 80%, preferably less than 78%, preferably less than 75%, allows a better dispersion of the particles as they are expelled in the jet of plasma or the flame, after the sheath has broken down. This improvement in the dispersion is notably particularly advantageous for high velocity plasma torches or flame torches, particularly those with axial injection.

This results in a better compromise between the following properties and characteristics:
optimal dispersion of the inorganic particles in the spray jet when this cord is used in a thermal spray method, without clamping-together of inorganic particles, thereby making it possible to obtain coatings with fine microstructures;
flexibility of the cord, making it easy to handle without the risk of breakage;
low enthalpy required to break down the organic compounds and convert them into non-toxic gases.

A cord according to the invention may also comprise one or more of the following optional and preferred features:
the ash content of the combined entity of the matrix and sheath of said cord is less than 5%, preferably less than 3%, as a percentage by mass based on the dry mass of said cord;
the median size D₅₀ of the collection of inorganic particles is less than 5 micrometers, preferably less than 4 micrometers, preferably less than 3 micrometers, preferably less than 1 micrometer, particularly in order to form a columnar structure;
the viscosity of the polymer binder of the core and/or of the sheath polymer and/or of the material that makes up the core and/or of the material that makes up the sheath is/are comprised between 30 and 300 mPa·s, or between 30 and 300 centripoise at 20° C., said viscosity being measured, with a Hoppler viscosimeter, on a mixture containing 2% by mass of a dry powder of the polymer binder of the core and/or of the sheath polymer and/or of the material that makes up the core and/or of the material that makes up the sheath, respectively, in demineralized water;
the sheath and/or the matrix is/are made of a cellulose derivative, which is to say an ingredient containing cellulose molecules, preferably methyl hydroxyethyl cellulose, a cellulose derivative having a viscosity and an associated low ash content that is particularly well suited to thermal spraying;
the inorganic particles represent more than 45%, preferably more than 50%, and/or preferably less than 70%, preferably less than 75%, as a percentage by volume based on the volume of the core of the cord, outside of any potential solvent;
the inorganic particles are:
   particles of one or more metal oxides, preferably of alumina, zirconia, of titanium oxide, of chromium oxide, of yttrium oxide, or of a combination of several of these oxides, for example mullite or spinel, and/or
   particles of carbide-based cermet, the carbides being able for example to be carbides of chromium and/or of tungsten and/or titanium and/or tantalum and/or zirconium and/or of niobium, said carbides being associated with a metallic phase, and/or
   inorganic particles containing SiC and the YAG (Yttrium-Aluminium Garnet) phase allowing thermal spraying of a compound based on SiC;
   particles of a ceramic, preferably selected from among nitrides, borides, or carbo-nitrides, possibly associated with a metallic phase in the form of cermets;
   particles made of a refractory metal or of a refractory metal alloy, preferably having a melting point higher than 2500 K;
   particles made of a special metal, preferably selected from amorphous metals, quasi-crystals or approximants, and more broadly, metal alloys that cannot be wire drawn;
   preferably particles made of a brittle material, preferably a brittle metal or an alloy of brittle metals;
the inorganic particles are selected from among particles made of ceramic, particles made of an alloy of metals, particles made of an amorphous metal, particles made of a quasi crystal or of an approximant phase;
the thickness of the sheath is greater than 100 micrometers, preferably greater than 150 micrometers, and preferably less than 400 micrometers;
for a cord with an outside diameter of 2.5 to 3.5 mm, the thickness of the sheath is comprised between 200 and 400 micrometers;
for a cord with an outside diameter of 1 to 2.5 mm, the thickness of the sheath is comprised between 100 and 250 micrometers;
the ash content of said cord is less than 2.5%, preferably less than 2%, preferably less than 1%, preferably less than 0.7%, preferably less than 0.5%, as a percentage by mass based on the dry mass of said cord;
the polymer binder and the optional matrix lubricant, which is identical to or different than that of the sheath, together represent more than 95%, preferably more than 97%, preferably more than 99%, preferably substantially 100%, as a percentage by volume based on the volume of the matrix, not accounting for any solvent residue;
the polymer binder, which is preferably a cellulose derivative, and more preferably a methyl hydroxyethyl cellulose, represents more than 5%, preferably more than 10% and/or less than 25%, preferably less than 20%, or even less than 15% as a percentage by volume based on the volume of the core of the cord, not accounting for any solvent residue;
the matrix represents preferably more than 25%, preferably more than 30%, preferably more than 40% or even more than 45% and/or preferably less than 70%, preferably less than 60%, preferably less than 55%, preferably less than 50% as a percentage by volume based on the volume of the core of the cord, not accounting for any solvent residue;
in one embodiment, the matrix comprises a matrix lubricant, the content of said matrix lubricant being greater than 5%, greater than 10% and/or less than 25%, or less than 20%, as a percentage by volume on the basis of the volume of the core of the cord, not accounting for the possible presence of solvent residue;
the matrix lubricant is selected from polyols, glycerides, particularly glycerol and the derivatives thereof, stearates, amino alcohols, preferably from glycerin and triethanolamine, and more preferably is glycerin;
the solvent of the matrix is water or a denatured alcohol, preferably water;
the residual solvent, preferably water, content in the core is less than 5%, as a percentage by mass on the basis of the dry mass of the core of the cord;
the matrix consists over 99%, preferably substantially 100% of an organic material, the percentage being a volume percentage;
the sheath polymer and the optional sheath lubricant together represent more than 95%, preferably more than 97%, preferably more than 99%, preferably substantially 100%, as a percentage by volume based on the volume of the sheath, not accounting for any solvent residue;
the sheath contains a sheath lubricant, identical to or different than the optional matrix lubricant and the content of which is greater than 10%, preferably greater than 20%, preferably greater than 30% and/or less than 50%, preferably less than 40%, as a percentage by volume on the basis of the volume of the sheath, not accounting for the possible presence of solvent residue;
the sheath polymer content is greater than 45%, preferably greater than 55%, preferably greater than 60% and/or preferably less than 80%, preferably less than 75%, preferably less than 70% as a percentage by volume based on the volume of the sheath, not accounting for any solvent residue;
the polymer binder and the sheath polymer contain an identical polymer, preferably containing, by way of polymer(s), only polymers that are identical, and preferably in the same proportions;
the impurities in the matrix and/or in the sheath consist, in respect of over 90%, preferably more than 95%, and preferably substantially 100% of them, of organic impurities and/or impurities containing the hydrogen element H and/or of metallic impurities;
the impurities in the matrix and/or in the sheath represent less than 5%, preferably less than 3%, preferably less than 1%, as a percentage by volume on the basis of the volume of the matrix and/or of the sheath, respectively, not accounting for any solvent residue;
the sheath contains a colorant pigment, which may be any colorant conventionally used, which represents less than 1%, preferably less than 0.5%, preferably less than 0.4%, preferably less than 0.1%, or even less than 0.05% of the volume of the sheath;
the solvent of the sheath is preferably water or a denatured alcohol, preferably water;
the residual solvent, preferably water, content in the sheath is less than 10%, preferably less than 5%, as a percentage by mass on the basis of the mass of the sheath of the cord;
the sheath consists over 99%, preferably substantially 100% of an organic material, the percentage being a volume percentage;
the cord is wound on itself in the form of a roll or of a reel, preferably wound onto a spool of a diameter greater than 50 mm, preferably greater than 100 mm, preferably greater than 150 mm, or even greater than 200 mm, and/or less than 1000 mm, preferably less than 500 mm, preferably less than 400 mm, preferably less than 300 mm.

A cord according to the invention is not intended for welding. As a preference, it does not contain any flux, which is an agent conventionally used for cleaning and deoxidizing the welding zone or to form a protective slag.

As a preference, a cord according to the invention does not contain any flux selected from spath fluor or calcium fluoride, cryolite which is a fluoride of alumina and of sodium, and borates.

The invention also relates to a thermal spray device comprising:
a torch comprising a plasma or flame generator and an injection device; and
a cord according to the invention arranged in such a way as to be able to be injected, by the injection device, into the plasma or the flame generated by said generator,
the torch being able to at least partially melt the inorganic particles of the cord and to spray the at least partially molten inorganic particles, preferably at over 150 m/s.

The torch is preferably able to spray the at least partially molten inorganic particles at over 150 m/s and/or at under 1000 m/s, the spray velocity being measured conventionally at the outlet of the torch. In one embodiment, the particles are sprayed at over 300 m/s, preferably at over 500 m/s, preferably at over 600 m/s, preferably at over 700 m/s. In one embodiment, the particles are sprayed at over 150 m/s and under 300 m/s.

The injection device is preferably arranged in such a way as to inject the cord along an injection axis extending in a radial plane passing through the axis X of the plasma stream or of the flame and making with a plane P transverse to the axis X an angle θ which, in terms of absolute value, is greater than 60°, greater than 70°, greater than 80° and preferably greater than 85°, the injection axis I preferably being substantially parallel to the axis X, the injection or “feed” of feedstock being qualified as “axial” injection or feed. The torch is preferably an axial-feed torch.

An angle θ close to 90° advantageously encourages uniform combustion of the sheath and of the matrix, and therefore uniform dispersion of the inorganic particles released into the stream of plasma or the flame at high velocity. This makes it possible to ensure a centered and optimal path of the particles in the jet nozzle of the torch and reduces the risk of fouling of the jet nozzle and therefore the risk of malfunctioning of the method and of defects in the coating.

As a preference, the injection is performed upstream of the jet nozzle through which the stream or “jet” of plasma or, in the case of a flame torch, the flame, flows. As a preference, for a flame torch, the cord is driven as far as the combustion chamber. As a preference, for a plasma torch, which is preferably a multi-cathode torch with axial injection of the material that is to be sprayed, the cord is driven as far as the zone of confluence of the elementary streams of plasma emanating from the cathodes, upstream of the jet nozzle through which the jet of plasma resulting from the merger of these two elementary streams of plasma flows.

Notably, a cord according to the invention has enough flexibility that it can be wound and unwound while being rigid enough to allow axial injection, preferably using a conventional drive device situated to the rear (upstream) of the torch.

The injection device preferably opens into the inside of the torch.

As illustrated in FIG. 1, the injection device is preferably arranged in such a way as to introduce the cord into the plasma or combustion chamber 17, preferably into a part 2 of the stream of plasma or of the flame that extends less than 10 cm, preferably less than 5 cm, and/or more than 2 cm, preferably more than 3 cm from the orifice or orifices 7 via which the stream(s) of plasma or the flame exits (exit) the generator.

The torch may in particular be an axial-injection multi-cathode plasma torch or a high velocity flame torch of HVOF or HVAF type or a conventional flame-wire torch or a torch of HVOF-Wire or HVAF-Wire type.

The invention also relates to a method for coating a surface of a substrate with a coating, in which method a cord according to the invention is injected into a stream of plasma or into a flame from a torch so as to spray, onto said surface, inorganic particles of the cord that have been at least partially melted in the stream of plasma or the flame.

The invention finally relates to a method for thermal spraying by means of a thermal spray device according to the invention, in which method the torch is fed with a cord according to the invention so as to create a coating at the surface of a substrate.

The substrate is preferably a substrate made of metal, of a ceramic, of a cermet, of a polymer, of an organic material or of a composite material, preferably one with a ceramic matrix.

The substrate may exhibit varying shapes, having for example planar geometries or geometries of revolution, notably cylindrical geometries, or complex geometries, the only limit being the accessibility by the jet of at least partially molten inorganic particles. Axial feed upstream of the spray nozzle or of the jet nozzle advantageously improves this accessibility.

In one embodiment, the coating provides the substrate with a surface functionality, preferably improving resistance to abrasion, modifying the coefficient of friction or creating a thermal or electrical insulation barrier.

The coating may notably be intended to afford thermal, chemical or mechanical protection to the components, particularly in a reactor, for example to create columnar thermal barriers on aeronautical turbine or stationary turbine components, environmental barriers on ceramic-ceramic composite components, or else create functional layers in solid electrolyte fuel cell devices, these applications being cited merely by way of examples.

The cord and the thermal spray device according to the present invention are most particularly advantageous for creating columnar-structure coatings and nanostructured coatings, by the spraying of sub-micron particles contained in said cord. However, they avoid the disadvantages of the SPS or SPPS methods. The “columnar structure” is notably described in the doctoral thesis by Benjamin Bernard relating to thermal barriers created by suspension plasma spraying, which can be consulted at the website: http://docnum.univ-lorraine.fr/public/DDOC_T_2016_0212_BERNARD.pdf.

Another advantage of the present invention is the possibility of creating, using thermal spraying, hybrid coatings, which is to say coatings containing different materials, from a cord containing particles with different physical-chemical natures.

The production of a hybrid coating may be achieved using the known thermal spraying techniques.

A hybrid coating may be obtained from a cord containing particles of a ceramic oxide material and metallic particles.

The invention makes it possible in particular to combine different materials that would be awkward to combine using other methods, because of their different sizes or densities. This is notably a major problem with the thermal spraying of suspensions or dry powders that need to be co-injected in thermal spraying.

### BRIEF DESCRIPTION OF THE FIGURES

Further features and advantages of the invention will become more clearly apparent on reading the following detailed description and on studying the appended drawing, in which:

FIG. 1 schematically illustrates a thermal spray device according to the invention;

FIG. 2 schematically illustrates the cross section of a cord according to the invention;

FIG. 3 schematically illustrates a device used in the examples to evaluate flexibility.

In the various figures, identical references have been used to designate elements that are identical or similar.

### Definitions

The “equivalent outside diameter” of a cord is the diameter of a disk having the same surface area as the cross section of the cord at mid-length.

The particle sizes corresponding to the percentages equal to 10%, 50% and 90% by number, on the cumulative particle-size distribution curve, of the sizes of particles of said collection of particles, said particle sizes being classified in increasing order, are referred to respectively as the 10th percentile (denoted D₁₀), the 50th percentile (denoted D₅₀) and the 90th percentile (denoted D₉₀). According to this definition, 10% by number of the particles of the collection of particles thus have a size smaller than D₁₀ and 90% by number of the particles have a size greater than or equal to D₁₀. The particle-size distribution curve may be created using a laser granulometer. The SYSMEX FPIA 3000 device may advantageously be used to obtain such curves.

The 50th percentile D₅₀ of a collection of particles is referred to as the “median size”. The median size therefore divides the particles of the collection of particles into the first and second populations that are equal in number, these first and second populations containing only particles having a size that is greater than or equal to or, respectively, less than, the median size.

The percentiles relating to the sizes of the inorganic particles of a cord are those measured in the powder of inorganic particles used to manufacture this cord. They can be estimated from the cord by removing the binder from the cord by calcination so as to eliminate the organic constituents and recover said inorganic particles. If the inorganic particles are capable of being oxidized and liable to be damaged by the binder-elimination temperature, the elimination of the binder is preferably carried out in a neutral atmosphere, for example in argon. The particle size distribution of the inorganic particles extracted by removal of binder can then be measured by volume, for example by laser granulometry. The particle distribution by volume can easily be calculated with respect to the volume of the cord, of the core or of the sheath, the dimensions of which can be measured for example using a micrometer or a caliper before and after the removal of the sheath of the cord.

The measurement of a percentage on the basis of the “dry mass” of the cord can be performed on a 100 g sample of the cord, after drying it at 110° C. for one hour.

When a volume percentage is calculated on the basis of the cord, of the core or of the sheath, the volume of the cord, of the core or of the sheath is that bounded by the exterior surface of the cord, of the core or of the sheath.

The lubricant content, by volume, can be evaluated from the quantity of lubricant introduced into the starting charge, at the time of manufacture. The lubricant may be liquid or solid (graphite, BN, etc.).

The concept of a “colorant pigment” is well known to those skilled in the art. A pigment is a powder which, during the manufacture of the cord, leads to a coloration. A colorant pigment conventionally takes the form of a powder having a median particle size smaller than 1 micrometer. A colorant pigment may in particular be an “oxide pigment”, which is to say one made up of oxides.

What is meant by “inorganic” particles is particles made from a non-organic material, which is to say a material that does not contain hydrocarbon chains as one of its main components. This family of material comprises metals, glasses and ceramics as well as composites made from metal, from glass or from ceramic. As a preference, the inorganic particles do not contain hydrocarbon chains.

A material that is neither metallic nor organic, for example that is selected from oxides, nitrides, carbides and chlorides, is termed a “ceramic”. Ceramic materials include, in particular, glasses, cermets and vitreous ceramics. Within the context of the present invention, diamond, graphite, graphene and the carbides of metals or of metalloids are considered as being ceramic materials.

What is meant by a “cermet” is a material containing at least two phases, at least one phase being ceramic and at least another phase being metallic.

The term “brittle” qualifies a material of which the domain of plastic deformation under load prior to breaking represents less than 5%, preferably less than 1% of the elastic-deformation domain, and is preferably substantially zero. In other words, the breadth of the range of stress loadings leading to plastic deformation without breakage represents less than 5%, preferably less than 1% of the breadth of the range of stress loadings leading to elastic deformation.

Those constituents of the cord whose presence is not desired, namely constituents other than the inorganic particles, the polymer binder, the sheath polymer and the optional lubricant(s) are referred to as “impurities”. Solvent residue is not considered to be an impurity. The impurities may comprise impurities present in the sources of raw materials, but also residues of additives used during the manufacture of the cord, for example plasticizer residue.

The “ash content” of the cord corresponds to the residue left behind by combustion of the sheath and of the matrix of the core of the cord. It may be determined by calcination in accordance with the standard NF T30-012, by measuring the difference in mass between the mass resulting from calcination at a temperature of 450° C., and the mass resulting from calcination at a temperature of 950° C. The temperature of 450° C. allows all the organic constituents to be broken down and the temperature of 950° C. allows the vaporisation of any residue liable to disturb the melting of the inorganic particles. The calcination needs to be sufficient to extract substantially all the organic constituents from the cord. It is preferably carried out for a sufficient duration for said extraction to be substantially total. The calcination time is therefore adapted to suit the dimensions of the sample of cord being analyzed.

The “volume content of mineral material” is measured by dividing the volume of mineral material by the volume of the core of the cord. According to the techniques well known to those skilled in the art, the volume of the core of the cord can be measured geometrically. The volume of mineral material is determined using the Archimedes method, by weighing the mineral material extracted from the core of the cord after the removal of the binder.

A percentage is determined as being “excluding solvent” when the basis on which this percentage is calculated does not account for any solvent that might be present. In particular, the solvent is preferably water, and the volume percentages, notably of inorganic particles, of polymer binder, of matrix lubricant, of sheath polymer or of sheath lubricant are then measured by dividing the volume of the constituent concerned by the volume of a dry base, namely without accounting for any water there might be. The base may in particular be
the core, in the case of the inorganic particles,
the matrix, in the case of the polymer binder and the matrix lubricant,
the sheath, in the case of the sheath polymer and the sheath binder.

In order not to account for the water, these percentages may be measured after complete drying-out.

In the present description, the qualifiers “upstream” and “downstream” are used with reference to the direction of flow, along a “flow axis” or “axis of flow” of the stream of plasma-generating gas or of the gases of the flame.

The expression “based on” conventionally means that the corresponding quantity is greater than 50% by mass.

A “transverse plane” is a plane perpendicular to the axis X.

A “radial plane” is a plane containing the axis X.

For the sake of clarity, a distinction is made between the “polymer binder” of the core of the cord and the “sheath polymer” of the sheath. The polymer binder and the sheath polymer may be identical or different.

Also for the sake of clarity, a distinction is made between the “matrix” binder and the “sheath” binder. These binders may be identical or different.

The terms “comprise”, “include”, “contain” and “have” should be interpreted broadly and without limitation,

### DETAILED DESCRIPTION

### Spray Device

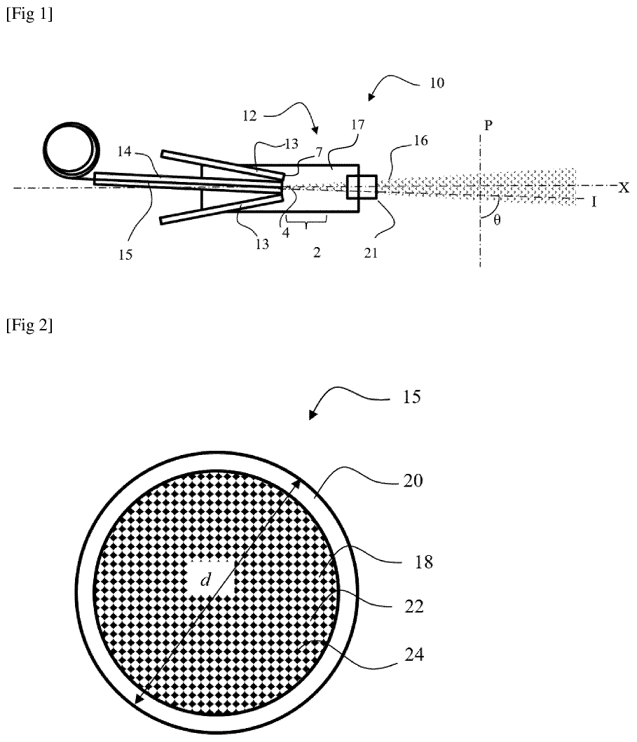

FIG. 1 schematically illustrates a thermal spray device 10 according to the invention, comprising a torch 12 and a cord 15 according to the invention feeding said torch with inorganic particles.

The torch may in particular be a multi-cathode torch allowing axial injection, a flame torch, preferably a high-velocity oxy-fuel (or HVOF) or high-velocity air-fuel (or HVAF) type torch or a conventional flame-wire torch or a torch of HVOF-Wire or HVAF-Wire type.

In the conventional way, the torch 12 comprises one or more plasma or, in the case of a flame torch, combustion-gas, generators 13, and an injection device 14 for injecting the cord 15 along an injection axis I through an injection orifice 4 into the stream 16 of plasma or the flame produced in the chamber 17, upstream of the spray nozzle or of the jet nozzle 21 of the torch.

The axis of the stream of plasma or of the flame is referred to as the “axis X”.

In a radial plane containing the axis X and passing through the center of the injection orifice, the projection of the injection axis I forms, with the axis X, an angle θ. The angle θ is preferably greater than 60°, greater than 70°, greater than 80°, and preferably greater than 85°. As a preference, the axis X is contained in said radial plane, preferably perfectly coincident with the axis X.

### Cord

FIG. 2 schematically illustrates the cross section of a cord 15 according to the invention. In particular it is possible to discern the core 18 and the sheath 20 surrounding the core.

The cord preferably has a cross section that is constant over the entire length of the cord. It preferably has a circular cross section and preferably has an equivalent outside diameter greater than 1.5 mm, preferably greater than 2 mm and/or less than 3.3 mm, preferably less than 3.2 mm, an equivalent outside diameter of 3 mm being preferred.

The cord is preferably wound onto a spool, preferably packaged in the form of a reel that can be easily handled and unwound to feed into the spray device.

As a preference, the cord contains no metal salts or hydroxides, for example does not contain any aluminum hydroxide (boehmite) that forms a gel during the preparation of the paste, and neither does it contain any ammonium acetate. This is because the inventors have found that these constituents mentioned in the prior art may have a negative impact. In particular, the formation of an inorganic gel, for example as a result of the use of aluminum hydroxides, causes the inorganic particles to clump together during spraying, and this means that not all of the individual fine particles can be released, and therefore is detrimental to the obtaining of finely structured layers. These constituents also lead to less flexibility in cords in which the inorganic particles have a median size smaller than 10 micrometers.

### Core

The core 18, in the form of a wire, preferably of a cross section that remains constant over the entire length of the cord, preferably has a circular cross section. Its equivalent outside diameter is preferably greater than 2 mm, and/or preferably less than 3.2 mm.

The core contains a collection of inorganic particles 22 which are intended to be melted to the form of droplets in the stream of plasma or the flame, and then sprayed onto a substrate in order to form a coating on the substrate.

These inorganic particles preferably represent more than 40%, preferably more than 50%, preferably more than 55% and/or less than 80%, preferably less than 75%, preferably less than 70%, preferably less than 65% of the volume of the core of the cord. A volume content of inorganic particles that is less than 40% increases the energy consumption required, during spraying, to break down the organic components of the binder matrix and of the sheath. A volume content of inorganic particles that is greater than 80% is detrimental to the flexibility of the cord.

The median size D₅₀ of the collection of inorganic particles is less than 10 micrometers. This very low median size is intended to make it possible to obtain a coating with a very fine structure.

The median size D₅₀ of the collection of inorganic particles is preferably less than 5 micrometers and preferably greater than 0.1 micrometer.

The median size of the collection of inorganic particles is preferably comprised between 1 to 5 micrometers in order to obtain a dense coating intended for affording mechanical and/or chemical protection.

The median size of the collection of inorganic particles is preferably comprised between 0.2 to 0.5 micrometers in order to obtain a coating formed of columnar or “feathery” layers with a more thermally insulating microstructure, notably for obtaining a thermal barrier.

A median size greater than 0.1 micrometer advantageously makes it possible to reduce problems with safety during the manufacture of the cord.

As a preference, the ratio R of the equivalent outside diameter d of the cord, in micrometers, to the median size D₅₀ of the inorganic particles, in micrometers, is comprised between 200 and 20 000, preferably greater than 500, preferably greater than 1000 and/or less than 10,000, preferably less than 5000, preferably less than 2000. A ratio R comprised between 200 and 1600 is particularly advantageous, notably in the case of cords intended for high-velocity flame or plasma torches with axial injection of feedstock material.

As a preference, (D₉₀−D₁₀)/D₅₀ is greater than 1 and/or less than 1.8.

In one embodiment, for a median size of inorganic particles comprised between 0.2 to 0.5 micrometers, the 10th percentile (D₁₀) of the collection of inorganic particles is preferably greater than 50 nm, preferably greater than 100 nm, preferably greater than 150 nm, and the 90th percentile (D₉₀) of the collection of inorganic particles is preferably less than 1000 nm, preferably less than 900 nm, preferably less than 850 nm.

In one embodiment, for a median size of inorganic particles comprised between 1 to 5 micrometers, the 10th percentile (D₁₀) of the collection of inorganic particles is preferably greater than 0.1 micrometer, preferably greater than 0.5 micrometers, and the 90th percentile (D₉₀) of the collection of inorganic particles is preferably less than 10 micrometers, preferably less than 8 micrometers.

The nature of the inorganic particles is determined according to the nature of the desired coating. As a preference, the inorganic particles are made from a material consisting, in respect of more than 80%, preferably more than 90%, preferably more than 95%, or even substantially 100% of their mass, of one or more of the following oxides, alone or in solid solution: Al₂O₃, SiO₂, ZrO₂, Cr₂O₃, and TiO₂.

The inorganic particles may be made from a non-oxide material, particularly selected from:
metal oxides, preferably being made of alumina, of zirconia, of titanium oxide, of chromium oxide, of yttrium oxide, or of a combination of several of these oxides, for example mullite or spinel, and/or
carbide-based cermets, the carbides being able for example to be carbides of chromium, of tungsten, of titanium, of tantalum, of zirconium, said carbides being associated with a metallic phase, and/or
SiC-YAG composites, YAG standing for Yttrium-Aluminum Garnet, enabling the thermal spraying of a compound based on SiC, and/or
ceramics such as nitrides, borides, and carbo-nitrides, possibly associated with a metallic phase in the form of cermets, and/or
refractory metals or of a refractory metal alloys, preferably having a melting point higher than 2500 K, and/or
alloys of special metals, such as amorphous metals, quasi-crystals or approximants, and more broadly, metal alloys that cannot be wire drawn.

The special metal alloys are conventionally alloys of metals, particularly alloys that undergo brittle mechanical breakage such as amorphous metals or metallic glasses, quasi-crystals or approximants (namely the approximant phases of quasi-crystals), as described for example at https://www.universalis.fr/encyclopedie/quasi-cristaux/4-phases-approximantes-et-defauts/.

As a preference, the inorganic particles are selected from among particles made of ceramic, particles made of an alloy of metals, particles made of amorphous metals, particles made of a quasi-crystal or of approximant phases.

Inorganic particles made of carbide are particularly well suited to the HVOF technology. The inorganic particles are embedded, preferably dispersed substantially uniformly, in a matrix 24 that binds said inorganic particles.

The matrix is substantially made up of an organic material, so that it can be reduced to the form of ash upon spraying.

The volume content of plasticizer may be greater than 1%, preferably greater than 4% and/or less than 10%, preferably less than 8%, as a percentage by volume on the basis of the volume of the core or of the matrix, excluding solvent. The plasticizer may be any known plasticizer, for example a phthalate, particularly BDP (ButylBenzyl Phthalate) or polyvinyl alcohol (known in its abbreviated form as PVA).

In one preferred embodiment, the complement to 100% of the polymer binder in the matrix contains, preferably consists of, excluding impurities and solvent residue, a lubricant, preferably glycerin. The lubricant may in particular constitute 10% to 20% of the volume of the core.

### Sheath

The sheath 20 contributes to the flexibility of the cord by enhancing its ability to be subjected to curvature without damage. In particular, it allows the cord to be wound without visible damage, notably without cracking or dissociation of its components. The sheath thus contributes to the tenacity of the cord, which is needed because of the small equivalent outside diameter of the cord, and confers a surface finish that encourages slippage, making it easier for the cord to advance through the injection orifice of the torch and limiting the wear brought about on those parts of the torch with which the cord is in contact, notably the injection orifice.

The sheath surrounds the core over the entire length of the cord. It preferably has a thickness that is constant in a plane perpendicular to the direction of the length of the cord, preferably in any arbitrary plane perpendicular to the direction of the length of the cord.

As a preference, the ratio of the thickness of the sheath, in micrometers, to the equivalent outside diameter of the cord, in micrometers, is greater than 0.03 and less than 0.6, preferably greater than 0.05, or even greater than 0.1 and/or less than 0.5, or even less than 0.3, or even less than 0.2. A ratio of between 0.05 and 0.5 is very particularly suitable when the collection of inorganic particles has a median size less than 5 micrometers.

As a preference, the main constituent of the sheath is a polymer from the same family, or even of the same chemical composition, or even of the same empirical formula as the polymer binder of the matrix of the core of the cord. The cross-linked monomer that forms the sheath polymer is preferably the same as that of the polymer binder.

The sheath polymer preferably represents between 55% and 75%, preferably approximately 65% of the volume of the sheath, excluding solvent.

As a preference, the sheath contains a lubricant referred to as “sheath lubricant”, preferably glycerin, in a content preferably greater than 25% as a percentage by volume on the basis of the sheath, excluding solvent. The sheath lubricant facilitates coextrusion at the time of its manufacture, limits the wear on those parts of the torch over which the cord slides, and, by facilitating slippage, limits the risk of buckling of the cord as it is injected into the stream of plasma or the flame, thereby contributing to the quality of the coating produced.

The complement to 100% of the sheath polymer and of the sheath lubricant preferably consists of organic impurities, particularly resulting from organic additives such as a plasticizer used for shaping the sheath of the cord as it is being manufactured.

In general, the compositions of the matrix and of the sheath are determined in such a way as to obtain a low ash content for the cord. The ash content, resulting from the presence of the polymer binder, of the matrix lubricant, of the sheath polymer, of the sheath lubricant and of the plasticizer which are used, is preferably less than 2.5%, preferably less than 2%, or even less than 1%, as a percentage by mass on the basis of the mass of the cord. Those skilled in the art know how to adapt a composition in order to reduce its ash content, possibly by conducting a few simple tests.

An ash content greater than 3% implies a high organic-components content and significant contamination of the torch. It results in significant disruption to the method and is a source of defects in the coating obtained by the thermal spraying.

In particular, preferably, the sheath polymer and/or the polymer binder of the matrix, preferably the organic charge consisting of the sheath polymer and of the polymer binder of the matrix consists/consist, in respect of more than 80%, more than 90%, more than 95%, preferably substantially 100% by mass, of cellulose derivatives, the percentage being by volume on the basis of the sheath or of the polymer binder, respectively, excluding solvent. A cellulose derivative advantageously allows a very low ash content, typically less than 1%, as a percentage by mass on the basis of the mass of the cord.

As a preference, the cellulose derivative is selected from cellulose ethers, preferably from methyl cellulose (MC), ethyl cellulose (EC), methyl ethyl cellulose (MEC), hydroxymethyl cellulose (HMC), hydroxyethyl cellulose (HEC), methyl hydroxyethyl cellulose (MHEC), hydroxymethyl ethyl cellulose (HMEC), hydroxypropyl cellulose (HPC), hydroxypropyl methyl cellulose (HPMC), hydroxypropyl ethyl cellulose (HEPC), carboxymethyl cellulose (CMC) and mixtures thereof. As a preference, the cellulose derivative is selected from hydroxyethyl celluloses, particularly methyl hydroxyethyl cellulose, because this sub-family of celluloses has rheological properties that are well suited to the manufacture of a small-diameter cord in which all the inorganic particles have a median size of less than 10 micrometers.

The alkali content, particularly the Na content, in the cellulose derivative is preferably less than 1% as a percentage by mass on the basis of the mass of said cellulose derivative. This feature advantageously makes it possible to limit the ash content and the long-term corrosion of the torches. As a preference, the cellulose derivative contains no or few cellulose fibers.

A cord according to the invention can be manufactured using any conventional method, particularly by coextrusion of a first paste intended to form the core of the cord and of a second paste intended to form the sheath. A method of this type is described in particular in FR 1 443 142.

A method such as that described in GB 1 151 091 A is particularly well suited.

The flexibility of the cord can easily be adjusted by adjusting the quantity of polymer binder in the core and the viscosity thereof and/or the viscosity of the sheath polymer.

### Applications

A cord according to the invention is particularly well suited to plasma torches, particularly plasma torches with axial injection, particularly multi-cathode plasma torches, also referred to as “multi-chamber” torches.

The flexibility of the cord according to the invention allows it to be wound around a spool so that it can be unwound while the coating is being created. Spraying may thus be substantially continuous. The sheath also ensures smooth contact with the injection orifice, thereby limiting the wearing of same.

The cord is, however, rigid enough to allow substantially axial injection, preferably using a drive device offset upstream of the torch. This axial injection encourages uniformity of the heating of the inorganic particles, evens out the distribution of the jet of inorganic particles in the jet nozzle, thereby limiting the fouling of same, and improves the repeatability and quality of the coating.

The limited quantity of liquid phase, and in particular of solvent, limits the amount of energy consumed and maximizes the energy available for pyrolyzing the sheath and the matrix and melting the inorganic particles.

The size of the inorganic particles is chosen according to the spray device and the microstructure desired for the coating.

From the moment the cord enters the chamber 17 of the torch, the following sequence of events occurs:
the sheath and the polymer binder are pyrolyzed;
the individual inorganic particles are released without any clumping-together effect;
the inorganic particles are rapidly entrained in the (flame or plasma) jet and completely or partially melted in flight,
the at least partially molten inorganic particles impinge upon the substrate and then solidify to create the coating.

In particular, the cord may be used to produce:
a coating affording mechanical or chemical protection, notably against corrosion by chemical species, vapors, etching plasma;
an environmental barrier or a thermal barrier;
a coating having a tribological function, an anti-wear coating, an electrically insulating coating, or an electrically conducting coating.

As a preference, the coating has a thickness of between 10 and 500 micrometers.

### Examples

The following non-limiting examples are given with the aim of illustrating the invention.

Example 1 was performed in accordance with the teachings of JP2016156058, by extruding the first paste.

For the other examples, a first paste was created, in accordance with the teachings of GB 1 515 091, from:
a powder of alumina particles, obtained by melting-solidification, with a median size of 7.5 micrometers and a purity higher than 99.5%, and
methyl hydroxyethyl cellulose (polymer binder) having a viscosity of 50 mPa·s.

The viscosity of the methyl hydroxyethyl cellulose was measured using a Höppler viscometer at 20° C. for a methyl hydroxyethyl cellulose powder mixed with demineralized water at a mass content of 2%.

The proportions, by mass, of the constituents of this first paste are indicated in Table 1 below.

A second paste intended to form the sheath was then prepared. To that end, the same methyl hydroxyethyl cellulose as that used to prepare the first paste was kneaded with a quantity of water, of glycerin and of colorant pigment according to the proportions by mass indicated in Table 1 below.

The first and second pastes were co-extruded in an extrusion press to obtain a 3 mm flexible cord precursor of substantially circular cross section with an outside diameter of 3 mm and having a sheath with a thickness of substantially 350 micrometers.

The drying of the cord precursors resulted in cords with a residual water content of less than 5%. The residual moisture measurements indicated a value of the order of 3%. The cords were wound onto a spool 70 mm in diameter.

### Diameters and Thicknesses

The outside diameter of the cord and the thickness of the sheath were measured using a digital Tesa Micromaster® 0-30 mm micrometer.

### Flexibility Test

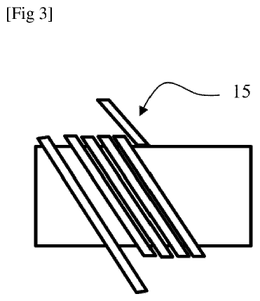

For each example:
a sample of at least 0.5 meters of the cord to be tested was wound around a cylindrical bar of a diameter of 25 mm, so as to form contiguous turns, as depicted in FIG. 3. This operation must not cause the cord to break;
a sample of at least 0.5 meters of the cord to be tested was wound around a cylindrical bar of a diameter of 70 mm, so as to form contiguous turns, as depicted in FIG. 3. The sheath of the cord must not exhibit cracks visible from the outside to the naked eye, or internal cracks visible from the outside to the naked eye through a color change resulting from the semi-transparency of the sheath;
a sample of at least 0.5 meters of cord was subjected to a cord-driving test that consisted in running a 2 kg roller of diameter 26 mm along the sample at a speed of 1 m/s. The cord is allowed to deform slightly and exhibit a variation in diameter of less than 15%, but it must not exhibit cracks visible from the outside to the naked eye.

If the cord passes these 3 tests, then its flexibility is acceptable. If it fails at least one of these three tests, its flexibility is unacceptable.

### Ash Content

The ash content is determined by (m₀−m₁)/m₀, m₀ and m₁ being respectively the masses, after calcination, of a 3 cm sample length of the cord in a furnace at 450° C. and 950° C., in air, respectively, for a duration of 1 hour.

### Ratio R

The ratio R is the ratio of the equivalent outside diameter of the cord, in micrometers, to the median size (D₅₀) of the inorganic particles, in micrometers.

### Variation in Enthalpy

The variation in enthalpy associated with the breakdown of the organic constituents of the cord at 2300 K was calculated using the Factsage® software for each example on the basis of its formulation, considering:
injection of the cord upstream of the flame or of the plasma stream, between the orifice via which the plasma stream or the flame leaves the generator and the spray nozzle (or jet nozzle);
in the case of a high velocity plasma torch, a neutral atmosphere, which is to say one without oxygen and without hydrogen and decomposition products from the breakdown of the cord of type CₓH_{y};
in the case of a high velocity oxy-flame (HVOF type) torch, an oxidizing atmosphere and a direct breakdown into CO₂ and H₂O;
a residual water measurement of 3% in the cord after drying.

The addition of organic compounds caused by the potential presence of a sheath was taken into consideration for determining the quantity and nature of the organic products of the cord.

In Table 1 below, the variation in enthalpy is given in kJ/mol of alumina.

The variation in enthalpy in a neutral atmosphere is considered to be particularly advantageous when it is as low as possible, particularly when it is less than or equal to, in terms of absolute value, 1000 kJ/mol of alumina.

The variation in enthalpy in an oxidizing atmosphere is considered to be particularly advantageous when it is less than +1000 KJ/mol of alumina.

The quantity of inorganic particles is given as a percentage by volume on the basis of the volume of the core of the cord, not accounting for solvent.

Example 1 (comparative example) performed in accordance with the teaching of JP2016156058 does not have a sheath. Example 3 (comparative example) was performed in accordance with the teaching of GB 1 151 091, but with finer inorganic particles. Examples 4* and 5* are in accordance with the invention.

TABLE 1

| | Invention | | | | | |
|---|---|---|---|---|---|---|
| Examples | Preferences | 1 | 2 | 3 | 4* | 5* |

Characteristics of the cord

| | | | | | | |
|---|---|---|---|---|---|---|
| Equivalent outside | 1000-3500 | 3000 | 3000 | 3000 | 3000 | 3000 |
| diameter (micrometers) | | | | | | |
| Ash content | <5% | <5% | <5% | <5% | <5% | <5% |

Formulation of the first paste for forming the core (mass %)

| | | | | |
|---|---|---|---|---|
| Quantity of inorganic | 75.7 | 37 | 80 | 65.8 |
| particles (alumina) | | | | |
| Polymer MHEC | 1.5 MHEC | 35 MHEC | 5 MHEC | 9.9 MHEC |
| Plasticizer (PVA) | 1.5 | 0 | 0 | 0 |
| Aluminum hydroxide | 3.8 | 0 | 0 | 0 |
| Lubricant (glycerin) | 0.8 | 5 | 5 | 5.3 |
| % water | 16.7 | 23 | 10 | 19 |

Formulation of the second paste for forming the sheath (mass %)

| | | |
|---|---|---|
| Polymer MHEC | NA | 24.7 MHEC |
| Lubricant (glycerin) | NA | 11.5 |
| Colorant | NA | 0.3 |
| % water | NA | 63.5 |

Characteristics of the core (vol % on the basis of the core, excluding solvent)

| | | | | | | |
|---|---|---|---|---|---|---|
| Inorganic particles | Alumina | Alumina | Alumina | Alumina | Alumina | Alumina |
| Quantity of inorganic | >40% | 6.3% | 81.1% | 25.5% | 73.4% | 61.0% |
| particles | | | | | | |
| D₅₀ of the inorganic | <10 mi- | 1.2 mi- | 7.5 mi- | 7.5 mi- | 7.5 mi- | 7.5 mi- |
| particles (micrometers) | crometers | crometers | crometers | crometers | crometers | crometers |
| Polymer binder of the | | 93.7% | 4.2% MHEC | 63.6% MHEC | 12.1% MHEC | 23.8% MHEC |
| matrix | | Cellulose | | | | |
| | | fibers | | | | |
| Plasticizer (PVA) | | 0% | 5.3% | 0% | 0% | 0% |
| Aluminum hydroxide | | 0% | 6.7% | 0% | 0% | 0% |
| Lubricant (glycerin) | | | 2.7% | 10.9% | 14.5% | 15.2% |

Characteristics of the sheath (vol % on the basis of the sheath, excluding solvent)

| | | | | | | |
|---|---|---|---|---|---|---|
| Polymer of the sheath | Cellulose | — | 65% MHEC | 65% MHEC | 65% MHEC | 65% MHEC |
| | derivatives | | | | | |
| Lubricant (glycerin) | | — | 35% | 35% | 35% | 35% |
| Thickness of the sheath | 100 to 500 | 0 | 350 | 350 | 350 | 350 |
| (micrometers) | | | | | | |
| Ratio R | Preferably | 2500 | >60 | 400 | 400 | 400 |
| | 200 to 20000 | | | | | |

Results

| | | | | | | |
|---|---|---|---|---|---|---|
| Flexibility test | Acceptable | Acceptable | Unacceptable | Acceptable | Acceptable | Acceptable |
| Variation in enthalpy | Neutral | <−1000 | −475 | −1530 | −825 | −710 |
| in kJ/mol of inorganic | atmo- | | | | | |
| particles material | sphere ≥−1000 | | | | | |
| | Oxidizing | >2000 | 480 | 2980 | 1250 | 920 |
| | atmo- | | | | | |
| | sphere <1000 | | | | | |

MHEC: methyl hydroxyethyl cellulose;
ND: not determined;
NA: not applicable

As is now clearly evident, the invention provides a cord which, because of its flexibility, may advantageously be introduced, continuously, substantially along the axis of the torch, into the heart of the flame or of the plasma. The inorganic particles are properly dispersed as they are sprayed. The properties of the thermal breakdown of the cord, particularly its very low variation in enthalpy at 2300 K, make it possible to obtain a coating that advantageously exhibits a roughness that is controlled and that is free of defects, for a limited energy consumption.

Of course, the invention is not limited to the examples and embodiments described which are provided by way of illustrative and non-limiting examples.

1. A cord intended to serve as feedstock for a thermal spray torch in order to create a coating, said cord having an equivalent outside diameter of between 1 mm and 3.5 mm and comprising:
a core in the form of a wire, and
a sheath covering the core along its entire length,
the core having
of a collection of inorganic particles of which the median size is less than 10 micrometers, the inorganic particles representing more than 40% and less than 80% of the volume of the core, said inorganic particles being particles of one or more metal oxides and/or particles of carbide-based cermet, and/or inorganic particles of SiC-YAG and/or particles containing or made of a ceramic material and/or particles made of one or more metals or metal alloys having a melting point higher than 2500 K and/or particles made of a special metal alloy; and
of a matrix binding said inorganic particles, the matrix comprising:
a polymer binder having, in respect of over 80% of its mass, of a cellulose derivative, and
optionally a matrix lubricant,
the polymer binder and the matrix lubricant together representing more than 90% of the volume of the matrix,
the sheath having a thickness of between 50 micrometers and 500 micrometers and comprising:
a polymer referred to as “sheath polymer” having, in respect of over 80% of its mass, of a cellulose derivative, and
the sheath polymer and the sheath lubricant together representing more than 90% of the volume of the sheath,
the volume percentages being determined without accounting for the possible presence of solvent residue,
the median size of a collection of particles being the 50th percentile of said collection of particles corresponding to a percentage of 50% by number, on the cumulative particle-size distribution curve, of the sizes of particles of said collection of particles, determined using a laser granulometer, said particle sizes being ranked in increasing order.

2. The cord as claimed in claim 1, wherein the ash content of said cord is less than 5%, the ash content being determined by (m0−m1)/m0, m0 and m1 being respectively the masses, after calcination, of a 3 cm sample length of said cord in a furnace at 450° C. and 950° C., in air, respectively, for a duration of 1 hour.

3. The cord as claimed in claim 2, wherein the ash content of said matrix and of the sheath of said cord is less than 1%.

4. The cord as claimed in claim 1, wherein the ratio of the equivalent outside diameter of the cord, in micrometers, to the median size of the collection of inorganic particles, in micrometers, is comprised between 200 and 20 000.

5. The cord as claimed in claim 1, wherein said ratio is comprised between 200 and 2000.

6. The cord as claimed in claim 1, wherein the median size D₅₀ of the collection of inorganic particles is less than 5 micrometers.

7. The cord as claimed in claim 1, wherein the viscosity of the polymer binder of the core and/or of the sheath polymer is comprised between 30 and 300 mPa·s at 20° C.

8. The cord as claimed in claim 1, wherein the sheath contains a sheath lubricant, the content of said sheath lubricant being greater than 10% and less than 50%, as a percentage by volume on the basis of the volume of the sheath, not accounting for the possible presence of a solvent.

9. The cord as claimed in claim 1, wherein the inorganic particles are selected from
particles of alumina, of zirconia, of titanium oxide, of chromium oxide, of yttrium oxide, or of a combination of several of these oxides, and/or
particles of cermet containing more than 50% by mass of a carbide selected from the carbides of chromium and/or of tungsten and/or of titanium and/or of tantalum and/or of zirconium, and/or of niobium, and/or
particles of a ceramic material in the form of a nitride, of a boride, or of a carbo-nitride, said ceramic material being optionally associated with a metallic phase in the form of cermet, and/or
particles of a brittle material, and/or
particles of an amorphous metal alloy, or of a quasi-crystal or approximant, or of a metal alloy that cannot be wire-drawn.

10. The cord as claimed in claim 1, wherein the thickness of the sheath is greater than 200 micrometers and less than 400 micrometers.

11. The cord as claimed in claim 1, wherein the polymer binder and the sheath polymer contain an identical polymer.

12. An assembly comprising a spool of a diameter less than 500 mm and a cord as claimed in claim 1, wound on said spool.

13. A thermal spray device comprising:
a torch comprising a plasma-stream or flame generator and an injection device; and
a cord as claimed in claim 1 arranged in such a way as to be able to be injected, by the injection device, into said plasma stream or said flame generated by said generator,
the torch being able to at least partially melt the inorganic particles and to spray the at least partially molten inorganic particles at over 150 m/s.

14. The thermal spray device as claimed in claim 13, wherein the injection device is arranged in such a way as to inject the cord along an injection axis extending in a plane passing through the axis of the plasma stream or of the flame and making with a plane perpendicular to said axis an angle θ which, in terms of absolute value, is greater than 60°.

15. The thermal spray device as claimed in claim 1, wherein the injection device is arranged in such a way as to inject the cord upstream of a spray nozzle of the torch or of a jet nozzle of the torch.
